(19) United States
(12) Patent Application Publication
(10) Pub. No.: US 2005/0228578 A1
(43) Pub. Date: Oct. 13, 2005

(54) Traffic monitoring system

(75) Inventor: Gianfranco Burzio, Orbassano (IT)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(73) Assignee: C.R.F. Societa Consortile per Azioni, Orbassano (IT)

(21) Appl. No.: 11/083,817

(22) Filed: Mar. 18, 2005

(30) Foreign Application Priority Data
Mar. 29, 2004 (EP) 04425217.9

(51) Int. Cl. G06G 7/76

(52) U.S. Cl. 701/117

(57) ABSTRACT

There is described a monitoring system (1) for monitoring traffic in a highway section, and including at least one detecting unit (2) installed in a sensor vehicle (3) circulating in the highway section to monitor traffic locally; and a remote central operating unit (4) communicating with the detecting unit (2) to receive local monitoring information. The detecting unit (2) includes a locating device (6) supplying information relative to the position of the relative sensor vehicle (3); a sensor device (5) supplying information relative to the position of objects and/or vehicles around the sensor vehicle (3); and a transmitting device (8) for transmitting the information supplied by the locating device (6) and sensor device (5). The remote central operating unit (4) includes a receiving device (9) for receiving the information transmitted by the detecting unit (2); and a processing unit (11, 12) for processing the information.

### BACKGROUND OF THE INVENTION

1. Field of the Invention

The present invention relates to a traffic monitoring system.

2. Technical Background

As is known, vehicle traffic control on ordinary road networks, and particularly traffic monitoring, is now a major issue subject to continual improvement to speed up traffic flow along highways and/or motorways and so improve road safety, the demand for which is particularly strong among both vehicle users and road traffic control agencies.

As a result, considerable effort has been expended over the past few years to improve traffic monitoring systems by increasing the scope and precision of monitoring information, though a good deal of work still remains to be done.

### SUMMARY OF THE INVENTION

It is therefore an object of the present invention to provide a vehicle traffic monitoring system designed to provide more accurate information when monitoring vehicles along any highway section.

According to the present invention, there is provided a monitoring system for monitoring traffic in a highway area and/or section, characterized by comprising at least one detecting unit installed in a sensor vehicle circulating in said highway area and/or section to monitor traffic locally; and a remote central operating unit communicating with said detecting unit to receive local monitoring information; said detecting unit comprising locating means supplying information relative to the position of the relative sensor vehicle, sensor means supplying information relative to the position of objects and/or vehicles around the sensor vehicle, and transmitting means for transmitting said information supplied by the locating means and sensor means; said remote central operating unit comprising receiving means for receiving the information transmitted by said detecting unit, and processing means for processing said information.

### BRIEF DESCRIPTION OF THE DRAWINGS

A non-limiting embodiment of the present invention will be described by way of example with reference to the accompanying drawings, in which:

FIG. 1 shows, schematically, a traffic monitoring system in accordance with the teachings of the present invention;

FIG. 2 shows a block diagram of a detecting unit forming part of the FIG. 1 monitoring system; and

FIG. 3 shows a block diagram of a remote central operating unit installed in a sensor vehicle forming part of the FIG. 1 monitoring system.

### DETAILED DESCRIPTION OF THE INVENTION

The present invention is substantially based on the principle of employing one or more “sensor” vehicles, each of which travels along a monitored highway section and/or area to locally determine traffic or flow of surrounding vehicles as it drives through, and to transmit local monitoring information to a remote central operating unit which, in turn, collects and appropriately processes the information to “reconstruct” actual traffic conditions in the highway section and/or area.

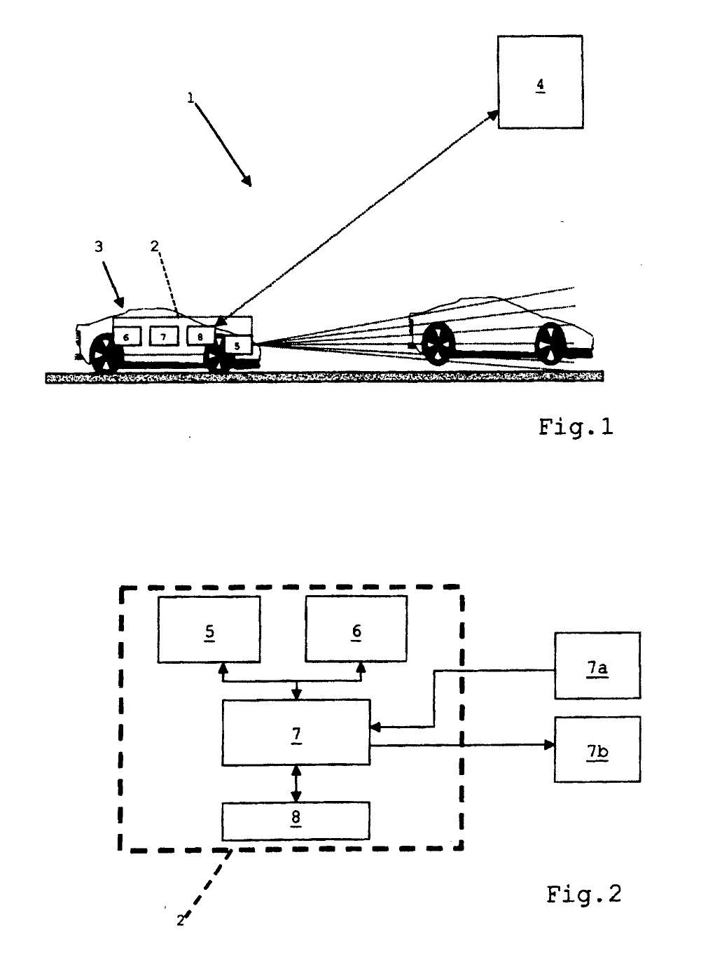

With reference to FIG. 1, number 1 indicates as a whole a vehicle traffic monitoring system, which substantially comprises a detecting unit 2 installed on a sensor vehicle 3 to locally monitor the area surrounding sensor vehicle 3, i.e. to pick up information relating to the presence of objects and/or vehicles in the vicinity of sensor vehicle 3 in the monitored highway area and/or section.

Traffic monitoring system 1 also comprises a remote central operating unit 4 which communicates with each detecting unit 2 to receive the traffic or flow information picked up locally by sensor vehicle 3, and to process it to determine the actual traffic conditions in the monitored highway area and/or section.

With reference to FIG. 2, detecting unit 2 comprises at least one sensor device 5 covering an area surrounding sensor vehicle 3 to pick up information concerning the movement of objects and/or vehicles travelling within the area and close to sensor vehicle 3; and a locating device 6 for determining, instant by instant, information concerning the movement of sensor vehicle 3.

Detecting unit 2 also comprises a processing unit 7 connected to sensor device 5 and to locating device 6 to receive and process the information relative to the movement of vehicles within the area covered by sensor device 5, and the information relative to the movement of sensor vehicle 3; and a communication device 8 for transmitting the information collected and processed locally by detecting unit 2 to remote central operating unit 4.

In the FIG. 2 example, sensor device 5 is defined by a television camera or by a radar sensor, e.g. an optical radar, which is preferably, though not necessarily, installed at the front of sensor vehicle 3 to pick up the presence of objects and/or vehicles in front of sensor vehicle 3. More specifically, the radar sensor—also indicated hereinafter by number 5—supplies information relative to each vehicle and/or object, stationary or moving, picked up within the front area covered by radar sensor 5. The information supplied by radar sensor 5 comprises parameters relative to the movement of each detected vehicle, such as position, speed, travelling direction, and type of vehicle and/or object (car, industrial vehicle, motorcycle, etc.).

System 1 may obviously also comprise other sensor devices 5 on the side/s of sensor vehicle 3 to pick up information concerning the presence of objects and/or vehicles alongside sensor vehicle 3, e.g. overtaking vehicles.

Locating device 6 may be defined by a GPS receiver installed on sensor vehicle 3 and cooperating with a GPS (Global Positioning System) satellite locating system (not shown) to determine, in known manner, the absolute position of sensor vehicle 3 in the highway area and/or section, together with other movement parameters of sensor vehicle 3, such as travelling speed, direction, etc.

With reference to FIG. 2, processing unit 7 is defined by a CPU (Central Processing Unit) connected to radar sensor 5 to receive information relative to the position, speed and travelling direction of each moving/stationary vehicle/object in front of sensor vehicle 3, and to locating device 6 to receive information relative to the position, speed and travelling direction of sensor vehicle 3.

Processing unit 7 preferably, though not necessarily, also cooperates with sensors and/or processing devices 7a normally installed on the sensor vehicle, to receive additional information relative to the operating status of sensor vehicle 3, such as operation or not of the windscreen wipers, indicating the presence/absence of rain, and/or operation or not of the headlights (e.g. fog lights) indicating the presence/absence of fog, and other environmental information such as temperature, humidity, etc.

Processing unit 7 processes the above information to supply, by means of a signalling device 7b, an audio or visual alarm to alert the user (not shown) of sensor vehicle 3 of an anomalous vehicle traffic situation caused, for example, by sudden deceleration of the vehicles covered in front of sensor vehicle 3, by an increase in traffic, or by an immediate hazard condition, such as a stationary vehicle/object along the road, an accident, a sudden reduction in visibility, or sudden increased risk of collision.

Processing unit 7 also enables transmission of monitoring information to remote central operating unit 4 over communication device 8, which is defined by a receiving-transmitting module for transmitting monitoring information to remote central operating unit 4. In the example shown, information is exchanged between receiving-transmitting module 8 of detecting unit 2 and remote central operating unit 4 over a preferably GSM or UMTS or GPRS or Wi-Fi communication network or system, or by any similar “wireless” communication system.

Remote central operating unit 4 provides for receiving local monitoring information picked up by each sensor vehicle 3, and for processing it to plot the detected traffic on a geographical map of the monitored highway area and/or section. In other words, remote central operating unit 4 processes the information picked up and transmitted by detecting unit 2 of each sensor vehicle 3, and reproduces it on the geographical map to reconstruct the traffic scenario in the monitored highway area and/or section.

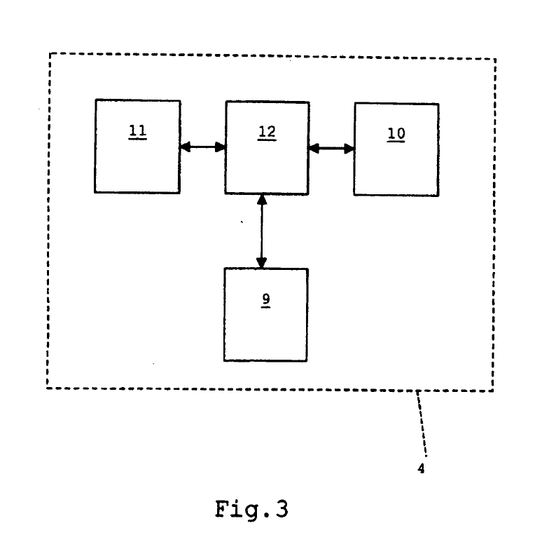

With reference to FIG. 3, remote central operating unit 4 substantially comprises a communication device 9 for remote communication with each detecting unit 2 to receive local monitoring information picked up by relative sensor vehicle 3; and a memory device 10 for memorizing the geographical map of the monitored highway area and/or section, and the information received from detecting units 2.

Remote central operating unit 4 also comprises a computing block 11 for entering and/or integrating on the geographical map information relative to the vehicles detected by detecting unit 2, so as to define the traffic or traffic flow scenario in the monitored highway area and/or section; and a processing and control block 12 for checking the traffic condition in the reconstructed scenario to determine any anomalous situations and/or hazard conditions.

More specifically, computing block 11 enters on the geographical map information relative to the position, movement and speed of each detected vehicle/object monitored locally, so as to reproduce on the map a vehicle movement condition corresponding to that in the monitored highway section and/or area. In the example shown, computing block 11 performs the following operations; plots each newly detected vehicle in the respective position on the geographical map; updates the parameters (speed and direction) governing movement of each vehicle on the map; and deletes from the map any previously collected information conflicting with the latest information picked up locally by detecting unit/s 2.

Computing block 11 also provides for simulating movement of the detected vehicles, even when these “move out” of the frame covered by sensor devices 5 of sensor vehicles 3; in which case, the simulation may assume that each vehicle no longer within the frame maintains the same mobility characteristics, and continues travelling on the map at a speed corresponding to the arithmetic mean of previously detected speeds.

Simulation by computing block 11 may cover the movement of vehicles no longer covered by sensor vehicles 3 but present on the geographical map, and may implement a statistical computation algorithm in which, for each vehicle no longer in the frame, a probability index of the vehicle no longer being in the highway area and/or section is calculated, and increases according to a known formula as a function of the time lapse since the last sighting. More specifically, the simulation may provide that, following a predetermined time interval since its last sighting, the out-of-frame vehicle is deleted for good from the geographical map. Should the same vehicle be sighted again by sensor vehicle 3, it is obviously plotted again in the correct position on the map by computing block 11.

Processing and control block 12 processes the information in the traffic scenario “reconstructed” and updated by computing block 11, to determine and indicate any anomalous conditions and/or road hazard situations. In the example shown, processing and control block 12 implements a known traffic computation algorithm which, on the basis of information in the reconstructed scenario, calculates a number of road traffic condition parameters, such as the number of vehicles passing at a given instant, their mean, maximum and minimum speeds, distances between vehicles, etc. On the basis of such parameters, processing and control block 12 determines and indicates sudden deceleration in traffic, and/or the presence of a stationary object/vehicle in the highway section and/or area, a road accident, and poor visibility (due to rain or fog). By processing the above parameters, processing and control block 12 also assesses the risk of collision between vehicles circulating in the highway area and/or section, and accordingly indicates a collision hazard condition.

The anomalous condition and/or hazard situation information picked up and supplied by processing and control block 12 may be transmitted to other vehicles circulating in the monitored highway area and/or section over a radio communication system, e.g. similar to that described above for receiving and transmitting information between each detecting unit 2 and remote central operating unit 4. The above anomalous conditions and/or hazard situations may obviously also be transmitted by processing and control block 12 over variable message panels and/or luminous indicator devices installed along the highway section to inform users of the traffic condition or developments ahead.

In actual use, each sensor vehicle 3, as it travels in the monitored highway area and/or section, picks up information, by means of sensor device 5, relative to the movement of vehicles circulating in the area covered ahead of sensor vehicle 3, and determines parameters relative to its own movement by means of locating device 6. As stated, at this stage, processing unit 7 processes the information to determine any hazard conditions to be indicated to the user, and at the same time enables transmission of the information to remote central operating unit 4.

It should be pointed out that information may be transmitted by detecting unit 2 continuously or at regular predetermined intervals, which may be varied dynamically and remotely by remote central operating unit 4. In the latter case, processing unit 7 stores the information temporarily, and conveniently synthesizes it to eliminate from the transmission any redundant information relative to vehicle conditions which are unchanged since the last transmission, e.g. a stationary object, or a vehicle whose previously transmitted dynamic characteristics remain unchanged.

Remote central operating unit 4 receives and processes the information picked up by each sensor vehicle 3, updates the traffic scenario on the geographical map following each transmission, and checks the “simulated” traffic condition on the geographical map to determine any anomalous or hazard conditions to be indicated to vehicle users in the monitored highway area and/or section.

System 1 as described above advantageously provides for assessing traffic at least around the sensor vehicle using only one vehicle, and may conveniently be applied to motorway sections to meet management demand for independent, reliable, accurate information concerning motorway traffic.

System 1 also has the big advantage of providing more accurate information when monitoring vehicles along any monitored highway section, and so more reliably determining any anomalous conditions and/or road hazard situations to be indicated to vehicle users, thus improving road safety. System 1, in fact, provides for sufficiently accurate traffic assessment even when the vehicle is stationary for servicing (e.g. in a lay-by) or when travelling in the emergency lane at a much different speed from that of normal traffic.

System 1 also has the big advantage of being extremely easy to produce, by employing communication (e.g. GSM, GPRS, UMTS) devices and devices such as surrounding-traffic radar and monitoring cameras already or soon to be installed on vehicles as accident-prevention driving aids.

Finally, the system is particularly advantageous by also cooperating with known devices employing conventional sensors installed permanently along the road (for vehicle speed and position information only, such as magnetic coils embedded in asphalt, etc.), and which transmit the traffic information picked up to remote central operating unit 4, which in turn processes and integrates it with information transmitted by the sensor vehicles to monitor the highway section more accurately.

Clearly, changes may be made to the system as described and illustrated herein without, however, departing from the scope of the present invention.

1) A monitoring system for monitoring traffic in a highway area, comprising:
a detecting unit installed in a sensor vehicle circulating in said highway area to monitor traffic; and
a remote central operating unit communicating with said detecting unit to receive local monitoring information,
said detecting unit comprising
locating means supplying information relating to the position of the sensor vehicle;
sensor means supplying information relating to the position of objects or vehicles around the sensor vehicle; and
transmitting means for transmitting the information supplied by the locating means and the sensor means,
said remote central operating unit comprising receiving means for receiving the information transmitted by the detecting unit, and processing means for processing said information.

2. A monitoring system as claimed in claim 1, wherein the processing means of the remote central operating unit comprise computing means for geographically plotting the information relating to the detected traffic on a geographical map of the monitored highway area.

3. A monitoring system as claimed in claim 2, wherein the processing means of the remote central operating unit comprise checking means for checking the traffic situation on said geographical map to indicate anomalous or road hazard conditions.

4. A monitoring system as claimed in claim 2, wherein the computing means enter on the geographical map information relating to the position, movement and speed of each object or vehicle detected by the sensor means.

5. A monitoring system as claimed in claim 1, wherein the sensor means comprise radar means for supplying information concerning the position of objects and/or vehicles in the highway area ahead of the sensor vehicle.

6. A monitoring system as claimed in claim 5, wherein the computing means enter on the geographical map information relating to the position, movement and speed of each object or vehicle detected by the sensor means.

7. A monitoring system as claimed in claim 1, wherein the locating means comprise GPS receiving means.

8. A monitoring system as claimed in claim 1, wherein the detecting unit comprises processing means for processing said information to supply, via a signalling device, an audio or visual alarm signal to warn a user of the sensor vehicle of a predetermined anomalous road situation.

9. A monitoring system as claimed in claim 1, wherein the remote central operating unit comprises transmitting means for transmitting information concerning the monitored traffic situation to vehicles circulating in the highway area.

10. A sensor vehicle for a traffic monitoring system as claimed in claim 1.

11. A sensor vehicle for a traffic monitoring system, said sensor vehicle having a detecting unit comprising:
locating means supplying information relating to the position of the sensor vehicle;
sensor means supplying information relating to the position of objects or vehicles around the sensor vehicle; and
transmitting means for transmitting the information supplied by the locating means and the sensor means to a remote central operating unit of said system.
